(19) United States
(12) Patent Application Publication
(10) Pub. No.: US 2013/0003114 A1
(43) Pub. Date: Jan. 3, 2013

(54) FACSIMILE CONTROL, INFORMATION PROCESSING APPARATUS AND FACSIMILE SYSTEM

(75) Inventor: Hirotoshi MAEHIRA, Nagoya-shi (JP)

(73) Assignee: BROTHER KOGYO KABUSHIKI KAISHA, Nagoya-shi (JP)

(21) Appl. No.: 13/415,654

(22) Filed: Mar. 8, 2012

(30) Foreign Application Priority Data
Jun. 28, 2011 (JP) 2011-143224

(51) Int. Cl. G06F 3/12

(52) U.S. Cl. 358/1.15

(57) ABSTRACT

A non-transitory computer-readable medium having a facsimile control program stored thereon and readable by a computer installed in an information processing apparatus, the facsimile control program, when executed by the computer, causes the computer to perform operations including: a generating and transmitting process of generating facsimile data based on a transmission target image and transmitting the generated facsimile data to a facsimile device; a setting receiving process of receiving a transmission setting of the facsimile data from a user; and a transmission setting data transmitting process of transmitting transmission setting data based on the transmission setting received by the setting receiving process to the facsimile device. The facsimile control program causes the computer to start the generating and transmitting process and the setting receiving process at the same time or start one of the processes during execution of the other process.

### CROSS-REFERENCE TO RELATED APPLICATIONS

This application claims priority from Japanese Patent Application No. 2011-143224 filed on Jun. 28, 2011, the entire subject matter of which is incorporated herein by reference.

### TECHNICAL FIELD

The present invention relates to a technique of transmitting facsimile data from an information processing apparatus to a facsimile device.

### BACKGROUND

There have been proposed a technique in which, in a PC-FAX system in which an information processing apparatus (PC) and a facsimile (FAX) device are connected to each other, a user inputs a telephone number of a transmission destination and the contents of a memo to be written on a cover page on a screen displayed by the information processing apparatus, and when the input is completed, the information processing apparatus generates FAX data and transmits the FAX data to the FAX device.

### SUMMARY

However, according to the above-described related art, although the telephone number of a transmission destination and the contents of a memo are not input items which are directly related to generation of FAX data corresponding to the main body of FAX, the FAX data is generated when all of these input items are input. As a result, there is a problem in that the time at which the FAX device having received the FAX data from the information processing apparatus starts transmitting the FAX data to an external FAX device is delayed.

Illustrative aspects of the present invention provide a technique of accelerating the time at which a FAX device starts transmitting FAX data to an external FAX device in a system in which an information processing apparatus is connected to the FAX device.

According to one illustrative aspect of the present invention, there is provided a non-transitory computer-readable medium having a facsimile control program stored thereon and readable by a computer installed in an information processing apparatus, the facsimile control program, when executed by the computer, causes the computer to perform operations comprising: a generating and transmitting process of generating facsimile data based on a transmission target image and transmitting the generated facsimile data to a facsimile device; a setting receiving process of receiving a transmission setting of the facsimile data from a user; and a transmission setting data transmitting process of transmitting transmission setting data based on the transmission setting received by the setting receiving process to the facsimile device, wherein the facsimile control program is configured to cause the computer to start the generating and transmitting process and the setting receiving process at the same time or start one of the generating and transmitting process and the setting receiving process during execution of another one of the generating and transmitting process and the setting receiving process.

According to another illustrative aspect of the present invention, there is provided an information processing apparatus, the information processing apparatus comprising: a setting receiving unit configured to receive a transmission setting of facsimile data from a user; a generating and transmitting unit configured to generate facsimile data based on a transmission target image and transmit the generated facsimile data to a facsimile device; and a transmission setting data transmitting unit configured to transmit transmission setting data based on the transmission setting received by the setting receiving unit to the facsimile device, wherein the information processing apparatus is configured to start operations of the generating and transmitting unit and the setting receiving unit at the same time or start operation of one of the generating and transmitting unit and the setting receiving unit during operation of another one of the generating and transmitting unit and the setting receiving unit.

According to still another illustrative aspect of the present invention, there is provided facsimile system comprising a facsimile device and an information processing apparatus, wherein the information processing apparatus comprises: a setting receiving unit configured to receive a transmission setting of facsimile data from a user; a generating and transmitting unit configured to generate facsimile data based on a transmission target image and transmit the generated facsimile data to the facsimile device; and a transmission setting data transmitting unit configured to transmit transmission setting data based on the transmission setting received by the setting receiving unit to the facsimile device, wherein the information processing apparatus is configured to start operations of the generating and transmitting unit and the setting receiving unit at the same time or start operation of one of the generating and transmitting unit and the setting receiving unit during operation of another one of the generating and transmitting unit and the setting receiving unit, and wherein the facsimile device comprises: a receiving unit configured to receive the facsimile data and the transmission setting data from the information processing apparatus; and a transmitting unit configured to transmit the facsimile data received by the receiving unit using the transmission setting data received by the receiving unit.

According to still another illustrative aspect of the present invention, there is provided a facsimile control method for an information processing apparatus, the facsimile control method comprising: a generating and transmitting step of generating facsimile data based on a transmission target image and transmitting the generated facsimile data to a facsimile device; a setting receiving step of receiving a transmission setting of the facsimile data from a user; and a transmission setting data transmitting step of transmitting transmission setting data based on the transmission setting received by the setting receiving step to the facsimile device, wherein the facsimile control program is configured to cause the computer to start the generating and transmitting step and the setting receiving step at the same time or start one of the generating and transmitting step and the setting receiving step during execution of another one of the generating and transmitting step and the setting receiving step.

Incidentally, the invention can be realized in various forms including a facsimile control method, and a recording medium in which a facsimile control program is recorded.

Further, the functions of respective units provided in the present invention are realized by hardware resources in which the functions are specified by their configurations, software resources in which the functions are specified by programs, or a combination of the hardware and software resources. Moreover, these functions of the respective units are not limited to being realized by hardware resources which are physically independent from each other.

According to the above-described illustrative aspects, it is possible to accelerate the time at which the facsimile device starts transmitting facsimile data to an external facsimile device.

### BRIEF DESCRIPTION OF THE DRAWINGS

FIG. 1 is a schematic diagram showing a configuration of a PC-FAX system according to a first exemplary embodiment;

FIG. 2 is a block diagram showing a simplified electrical configuration of a PC;

FIG. 3 is a block diagram showing a simplified electrical configuration of a FAX device;

FIG. 4 is a data flow diagram of the PC-FAX system;

FIG. 5 is a schematic diagram showing an example of a transmission setting screen;

FIG. 6 is a schematic diagram showing an example of an address book screen;

FIG. 7 is a schematic diagram showing an example of an attachment setting screen;

FIG. 8 is a schematic diagram showing an example of a transmittal document preview screen;

FIG. 9 is a schematic diagram for conceptually explaining a merging by a merging process;

FIG. 10 is a flowchart showing processes by a FAX driver program;

FIG. 11 is a flowchart showing processes by a transmission setting program; and

FIG. 12 is a flowchart showing processes by a FAX device-side control program.

### DETAILED DESCRIPTION

Exemplary embodiments of the present invention will now be described with reference to the drawings.

### First Exemplary Embodiment

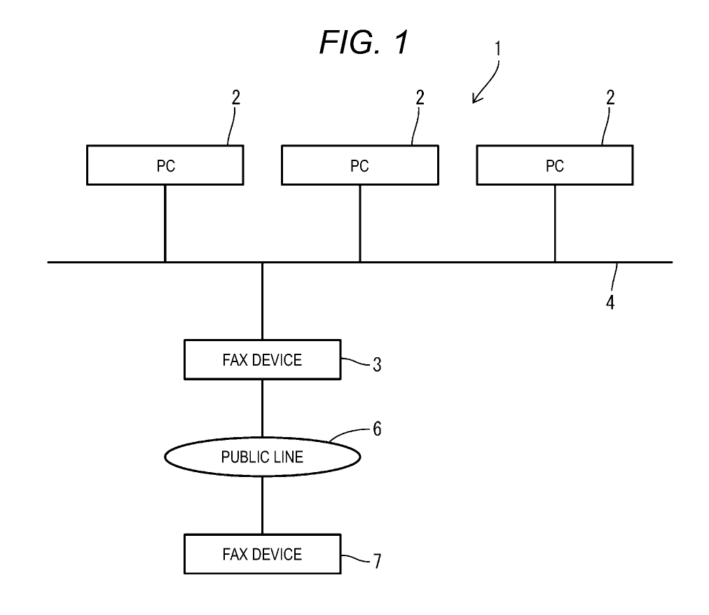

A first exemplary embodiment of the present invention will be described with reference to FIGS. 1 to 12.

(1) Configuration of PC-FAX System

FIG. 1 is a schematic diagram showing the configuration of a PC-FAX system 1 as a facsimile (FAX) system according to the first exemplary embodiment. The PC-FAX system 1 includes a personal computer (PC) 2 as an information processing apparatus and a facsimile (FAX) device 3, which are communicably connected to each other through a wired or wireless communication network 4 such as a local area network (LAN) or the Internet. The FAX device 3 is communicably connected to an external FAX device 7 through a public line 6.

The PC-FAX system 1 is a system in which, when the PC 2 receives a transmission setting for FAX transmission from a user, the PC 2 transmits transmission setting data based on the received transmission setting and body data (which will be described later) to the FAX device 3, and the FAX device 3 transmits the body data to the external FAX device 7 using the transmission setting data.

(1-1) Configuration of PC

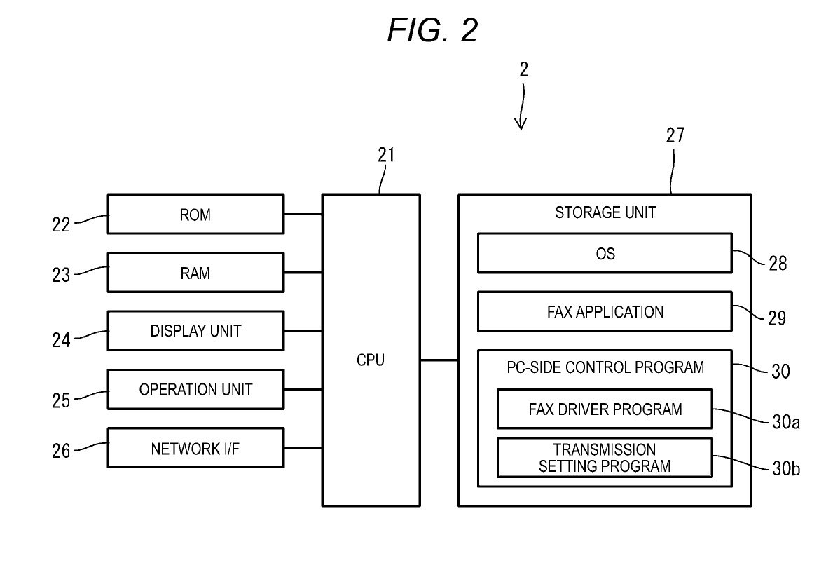

FIG. 2 is a block diagram showing a simplified electrical configuration of the PC 2. The PC 2 is configured to include a CPU 21, a ROM 22, a RAM 23, a display unit 24, an operation unit 25, a network interface (network I/F) 26, and a storage unit 27.

The CPU 21 controls the respective units of the PC 2 by executing various programs stored in the ROM 22 and the storage unit 27. Various programs and data executed by the CPU 21 are stored in the ROM 22. The RAM 23 is used as a main storage device for allowing the CPU 21 to execute various processes.

The display unit 24 is configured to include a display device such as a liquid crystal display and a driving circuit for driving the display device.

The operation unit 25 is configured to include an input device such as a mouse or a keyboard and a connection interface to which these input devices are connected.

The network interface 26 is communicably connected to an external device such as the FAX device 3 through the communication network 4.

The storage unit 27 is configured to store various programs and data using a nonvolatile memory such as a hard disk or a flash memory. An operating system (OS) 28, a FAX application program (FAX application) 29, a PC-side control program 30, and various data are stored in the storage unit 27. The OS 28 is a multi-task OS capable of executing a plurality of programs in parallel.

The PC-side control program 30 is an example of a facsimile control program. The CPU 21 and the operation unit 25 are examples of a setting receiving unit. Moreover, the CPU 21 and the network interface 26 are examples of a generation and transmitting unit and a transmission setting data transmitting unit.

(1-2) Electrical Configuration of FAX Device

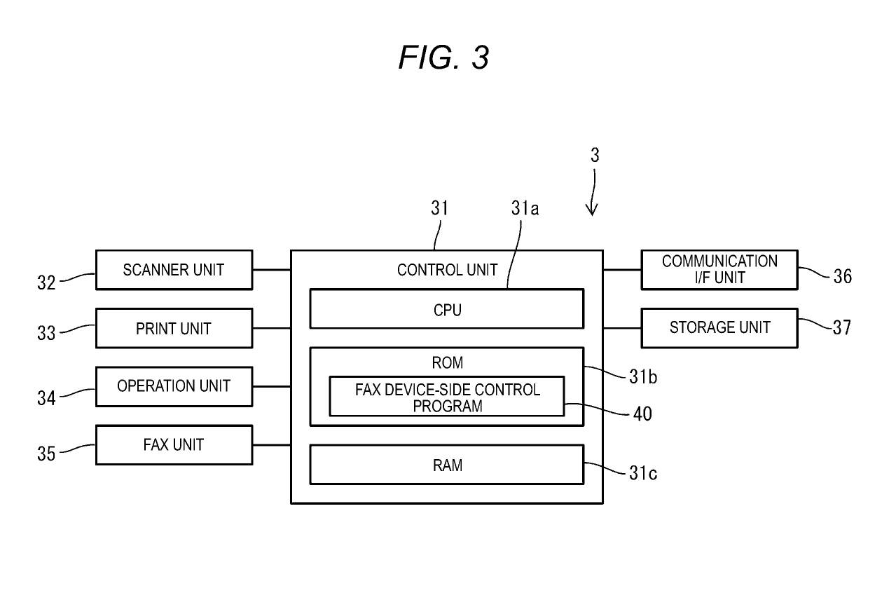

FIG. 3 is a block diagram showing a simplified electrical configuration of the FAX device 3. The FAX device 3 includes a control unit 31, a scanner unit 32, a print unit 33, an operation unit 34, a FAX unit 35, a communication interface (communication I/F) unit 36, and a storage unit 37.

The control unit 31 includes a CPU 31a, a ROM 31b, and a RAM 31c. The CPU 31a controls the respective units of the FAX device 3 by executing programs stored in the ROM 31b and the storage unit 37. A FAX device-side control program 40 for controlling the operation of the FAX device 3 and various data are stored in the ROM 31b. The RAM 31c is used as a main storage device for allowing the CPU 31a to execute various processes.

The scanner unit 32 includes a light source for illuminating a document and a linear image sensor. The scanner unit 32 is configured to optically read the document to generate an image. The image generated by the scanner unit 32 is transmitted to the external FAX device 7 by the FAX unit 35.

The print unit 33 prints the image represented by the FAX data received by the FAX unit 35 from the external FAX device 7 on a sheet by an electrophotographic method, an ink jet method, and so on.

The operation unit 34 is configured to include a display device such as a liquid crystal display or various buttons.

The FAX unit 35 is configured to include a network control unit (NCU), a modem, and an ASIC for controlling the network control unit and the modem. The FAX unit 35 transmits and receives FAX data to and from the external FAX device 7 through the public line 6 in accordance with a predetermined FAX communication protocol.

The communication interface unit 36 is communicably connected to an external device such as the PC 2 through the communication network 4.

An NVRAM and a flash ROM are included in the storage unit 37. A telephone number registered by the user, the body data and transmission setting data received from the PC 2 are stored in the storage unit 37.

The control unit 31 and the communication interface unit 36 are examples of a receiving unit. The control unit 31 and the FAX unit 35 are examples of a transmitting unit. The storage unit 37 is an example of a memory. Moreover, the control unit 31 is an example of a deleting unit.

(2) Data Flow of PC-FAX System

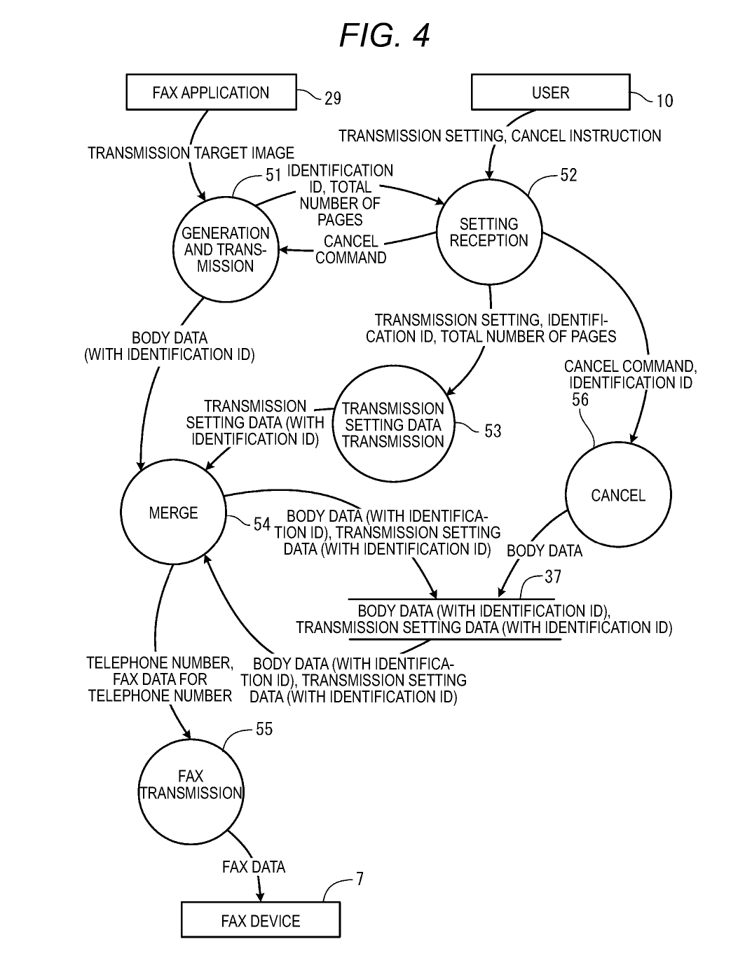

FIG. 4 is a data flow diagram of the PC-FAX system 1. Among the processes shown in FIG. 4, a generating and transmitting process 51, a setting receiving process 52, and a transmission setting data transmitting process 53 are processes executed by the PC 2. A merging process 54, a FAX transmitting process 55, and a cancellation process 56 are processes executed by the FAX device 3.

(2-1) Generating and Transmitting Process

The generating and transmitting process 51 is a process of executing a process of generating body data made up of one or more page data based on a transmission target image output from the FAX application 29 and outputting the generated body data to the merging process 54.

The body data is an example of facsimile data.

In the first exemplary embodiment, before starting the execution of the generating and transmitting process 51, a setting of generation conditions necessary for generation of FAX body data are input in advance from the user to the FAX application 29 and the FAX driver program 30a. Examples of the generation conditions include color/monochrome, a sheet size, and a resolution.

After the generation conditions are input, when a transmission instruction is input from the user to the FAX application 29, the transmission target image is output from the FAX application 29.

When the transmission target image is output from the FAX application 29, first, the execution of the generating and transmitting process 51 is started. When the execution of the generating and transmitting process 51 is started execution, the generating and transmitting process 51 first instructs the execution of the setting receiving process 52. After that, the generation and transmission of the body data by the generating and transmitting process 51 and the reception of the transmission setting by the setting receiving process 52 are executed in parallel.

Hereinafter, the processes executed by the generating and transmitting process 51 will be described.

(2-1-1) Process of Generating Identification ID

Upon receiving the transmission target image, the generating and transmitting process 51 generates an identification ID for uniquely identifying body data in the FAX device 3 before starting the generation of body data. The identification ID is used for correlating respective body data in the FAX device 3 with transmission setting data (which will be described later) when a plurality of body data is transmitted from a plurality of PCs 2 to the FAX device 3 at the same time. Incidentally, the identification ID is one example of identification information.

When generating the identification ID, a hash function may be used so that the generated identification ID does not overlap with identification IDs generated by a generating and transmitting process 51 that is executed by other PCs 2. Incidentally, instead of generating the identification ID by the generating and transmitting process 51, the FAX device 3 may generate unitarily identification IDs so as not to overlap with those of other PCs 2, and the identification IDs may be acquired from the FAX device 3.

(2-1-2) Process of Outputting Identification ID to Setting Receiving Process 52

After generating the identification ID, the generating and transmitting process 51 outputs the identification ID to the setting receiving process 52 before starting the generation of body data.

(2-1-3) Process of Generating Body Data

As described above, the generating and transmitting process 51 generates body data based on the transmission target image output from the FAX application 29.

As a data format of the body data, an MH compressed format, an MR compressed format, and an MMR compressed format which are generally used in FAX data transmission can be used. Any of these data formats allows linking FAX transmittal document data to the head of body data and associating header data and footer data with each of page data items that configure the body data.

(2-1-4) Process of Outputting Body Data and Identification ID to Merging Process 54

Each time page data corresponding to one page is generated, the generating and transmitting process 51 according to the first exemplary embodiment adds an identification ID to the generated page data and outputs the page data to the merging process 54 rather than transmitting body data to the merging process 54 after the generation of all page data configuring body data is completed. The reason for transmitting the page data each time page data corresponding to one page is generated is because FAX transmission can be performed efficiently by executing generation and transmission of page data in parallel.

(2-1-5) Process of Outputting Total Number of Pages to Transmission Setting Data Transmitting Process 53

After the generation of body data is finished, the generating and transmitting process 51 outputs a total number of pages of the page data configuring the body data to the transmission setting data transmitting process 53 through the setting receiving process 52. The total number of pages output to the transmission setting data transmitting process 53 is used for generation of FAX transmittal document data and header data.

(2-1-6) Process of Canceling Generation and Transmission of Body Data

When a cancel command is output from the setting receiving process 52, the generating and transmitting process 51 cancels the generation and transmission of body data.

(2-2) Setting Receiving Process

The setting receiving process 52 is a process of executing a process of receiving a transmission setting of FAX data from the user 10 and outputting the received transmission setting to the transmission setting data transmitting process 53.

Here, specific examples of the transmission setting include a telephone number of a transmission destination of FAX data and transmittal document information for generating a FAX transmittal document attached to FAX data, which are different from the generation conditions necessary for generating the body data but are data necessary for transmission of FAX data. The telephone number of the transmission destination of FAX data is an example of an address. The transmittal document information is an example of information used for generation of a transmittal document.

Hereinafter, processes executed by the setting receiving process 52 will be described.

(2-2-1) Process of Receiving Setting of Telephone Number of Transmission Destination

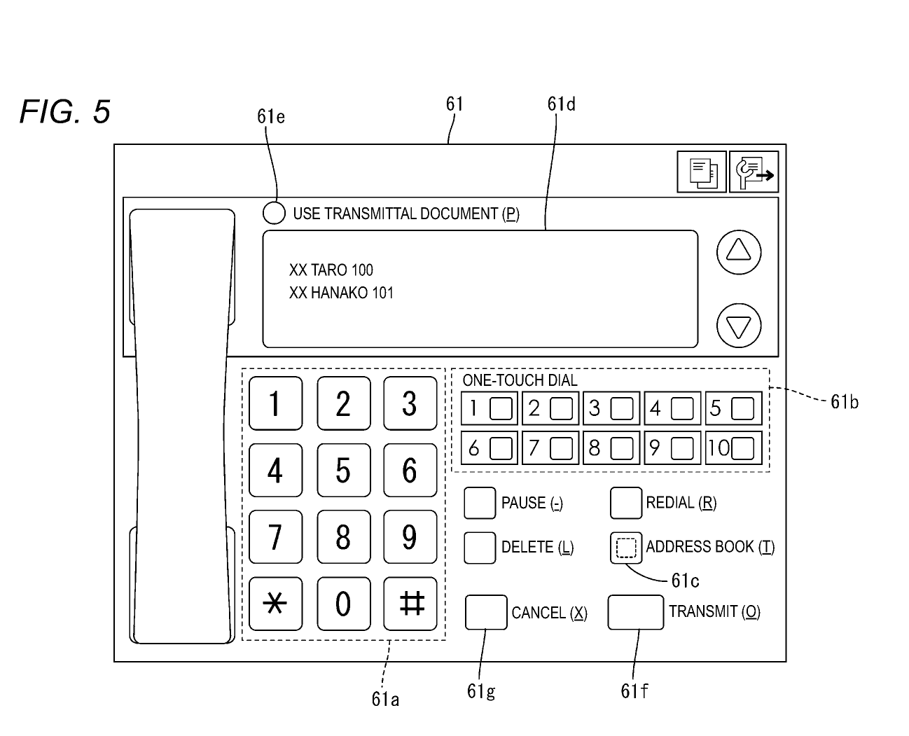

FIG. 5 is a schematic diagram showing a transmission setting screen 61 displayed by the setting receiving process 52. In the transmission setting screen 61, a user 10 can set a telephone number by the following methods (a) to (c).

(a) The user 10 can directly input the telephone number of the FAX device 7 of a transmission destination by clicking a number button 61a. The user 10 can input one or more telephone numbers, and the input telephone numbers are displayed in a transmission destination field 61d.

(b) The user 10 can designate a telephone number correlated with a shortcut number 61b by clicking any one of the shortcut numbers 61b displayed as one-touch dials. The user 10 can click one or more shortcut numbers 61b, and the name or the telephone number correlated with the clicked shortcut number 61b is displayed in the transmission destination field 61d.

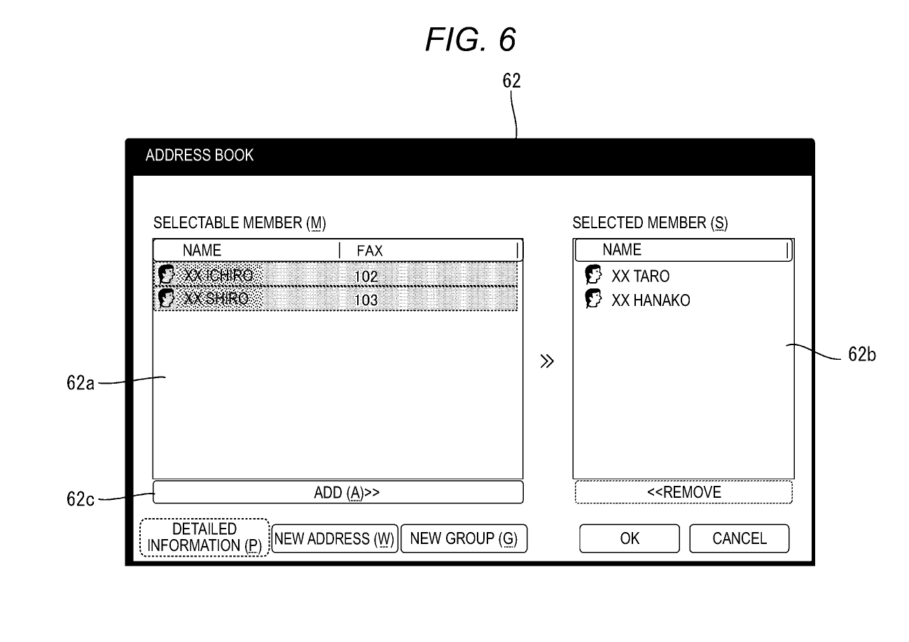

(c) The user 10 can select a transmission destination in an address book screen 62 (see FIG. 6) displayed when an address book button 61c is clicked.

FIG. 6 is a schematic diagram showing an example of the above-described address book screen 62. “Member” shown in the figure represents a transmission destination of FAX transmission, and a telephone number used when transmitting FAX to the member is correlated with each member.

In the address book screen 62, a selectable member field 62a is a field in which members registered in advance are displayed as a list, and a selected member field 62b is a field in which members selected as a transmission destination are displayed as a list. The user 10 can move a member to the selected member field 62b by selecting a member displayed in the selectable member field 62a with a mouse and clicking a “add” button 62c.

The user 10 can select one or more members in the address book screen 62, and the selected member or the telephone number thereof is displayed in the transmission destination field 61d.

(2-2-2) Process of Receiving Setting of Transmittal Document Information

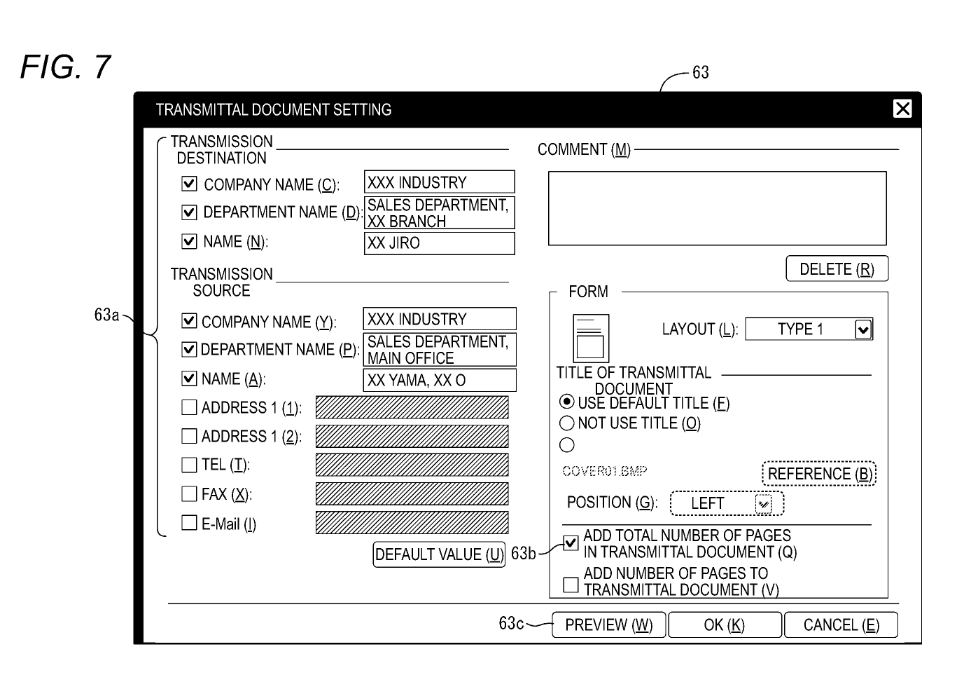

Returning to FIG. 5, when the user 10 selects a transmission destination displayed in the transmission destination field 61d of the transmission setting screen 61 with a mouse and clicking a “use transmittal document” button 61e in a state where the transmission destination is selected, the user 10 can display a transmittal document screen 63 (see FIG. 7) used for setting transmittal document information used for generating a FAX transmittal document attached to FAX data which is transmitted to a selected transmission destination.

FIG. 7 is a schematic diagram showing an example of the transmittal document setting screen 63. In the transmittal document setting screen 63, checkboxes 63a are provided to the left of respective items related to a transmission destination and respective items relating to a transmission source. When the checkbox 63a is checked, data can be input to an input field for inputting contents to be written in relation to the corresponding item. Then, the user 10 can input contents to be written in relation to the corresponding item to the input field.

Further, in the transmittal document setting screen 63, the user 10 can set such that a total number of pages is written in the FAX transmittal document by checking a checkbox 63b.

The user 10 can display a transmittal document preview screen 64 by clicking a “preview” button 63c in the transmittal document setting screen 63.

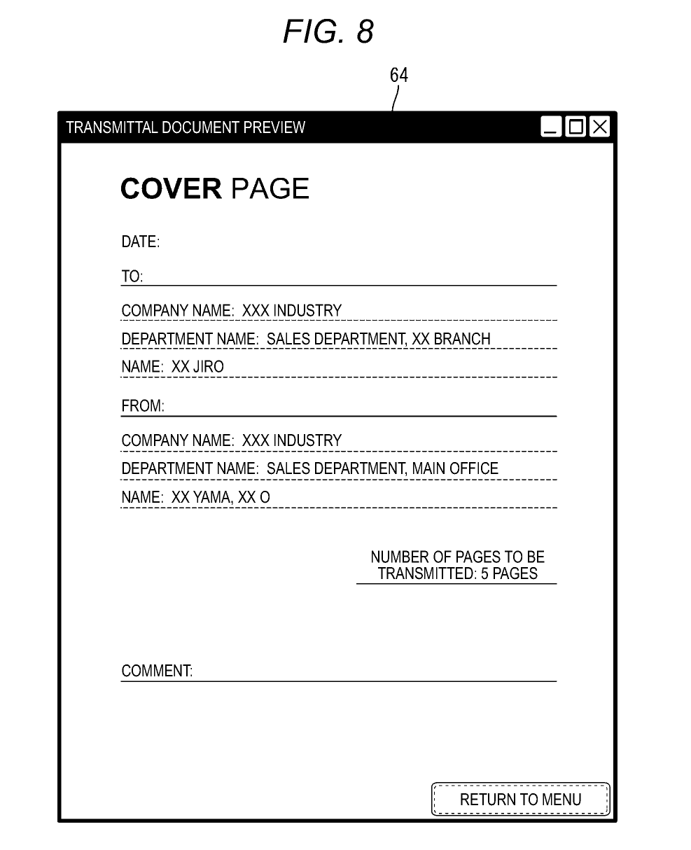

FIG. 8 is a schematic diagram showing an example of the transmittal document preview screen 64 displayed when the “preview” button 63c is clicked in a state where transmittal document information is set as in the example of the transmittal document setting screen 63 shown in FIG. 7. As shown in the figure, a FAX transmittal document that is actually transmitted is displayed as a preview in the transmittal document preview screen 64, and the user 10 can check the contents of the FAX transmittal document before transmitting FAX. Incidentally, the total number of pages received from the generating and transmitting process 51 is displayed in a field for displaying the number of pages to be transmitted in the transmittal document setting screen 64. Further, when the “preview” button 63c is clicked before the total number of pages is output from the generating and transmitting process 51, a balloon help such as a message, “Input page number when transmitting facsimiles” may be displayed.

(2-2-3) Process of Outputting Transmission Setting and Identification ID

Returning to FIG. 5, when the user 10 clicks a transmit button 61f on the transmission setting screen 61, the setting receiving process 52 outputs the set telephone numbers, transmittal document information corresponding to each telephone number, and various other setting information set in the transmission setting screen 61 and the transmittal document setting screen 63 to the transmission setting data transmitting process 53 as transmission setting.

In this case, the setting receiving process 52 outputs the identification ID and the total number of pages output from the generating and transmitting process 51 to the transmission setting data transmitting process 53 together with the transmission setting as shown in FIG. 4.

(2-2-4) Process of Receiving Command to Cancel FAX Transmission

The user 10 can cancel FAX transmission by clicking a cancel button 61g on the transmission setting screen 61.

As described above, the setting receiving process 52 can execute in parallel with the generating and transmitting process 51. Thus, when the cancel button 61g is clicked, and the generation and transmission of the body data by the generating and transmitting process 51 is being executed, the setting receiving process 52 outputs a cancel command to the generating and transmitting process 51 in order to cancel these processes, as shown in FIG. 4.

There may be a case in which, at a time when the cancel button 61g is clicked, a part or all of page data may have been transmitted from the generating and transmitting process 51 to the FAX device 3. Thus, when the cancel button 61g is clicked, the setting receiving process 52 outputs a cancel command and an identification ID to a cancellation process 56 in order to delete page data having been received on the FAX device 3 side, as shown in FIG. 4.

Incidentally, the setting receiving process 52 may output the cancel command to only the cancellation process 56 and may not output the cancel command to the generating and transmitting process 51. In this case, even when the cancel command 61g is clicked, page data are output from the generating and transmitting process 51 to the FAX device 3, and the page data in the FAX device 3 are deleted by the cancellation process 56.

A process in which the setting receiving process 52 receives the click of the cancel button 61g from the user 10 is an example of a cancel receiving process of receiving a cancel instruction. Further, a process in which the setting receiving process 52 outputs a cancel command to the cancellation process 56 is an example of a cancellation process.

(2-3) Transmission Setting Data Transmitting Process

Returning to FIG. 4, the transmission setting data transmitting process 53 generates a telephone number list based on one or more telephone numbers included in the transmission setting output from the setting receiving process 52. Further, the transmission setting data transmitting process 53 generates FAX transmittal document data for each telephone number based on the transmittal document information included in the transmission setting and the total number of pages output from the setting receiving process 52. Still further, the transmission setting data transmitting process 53 generates header data to be added to each page data using the total number of pages.

Then, the transmission setting data transmitting process 53 adds the identification ID output from the setting receiving process 52 to the transmission setting data including the telephone number list, the FAX transmittal document data of each telephone number, and the header data of each page data and outputs the transmission setting data to the merging process 54.

The transmission setting data transmitting process 53 according to the first exemplary embodiment is started at least when the generating and transmitting process 51 has generated all of the page data. The reason is because the total number of pages to be written to the FAX transmittal document and the header is not determined until all of the page data are generated. Incidentally, when it is set such that the total number of pages is not to be written to the FAX transmittal document and the header, the transmission setting data transmitting process 53 may be started before all of the page data are generated.

(2-4) Merging Process

The merging process 54 identifies the body data output from the generating and transmitting process 51 and the transmission setting data output from the transmission setting data transmitting process 53 by the identification IDs added thereto. Then, the merging process 54 generates FAX data for each telephone number by merging the corresponding body data and the corresponding transmission setting data and outputs telephone numbers and FAX data corresponding to each of the telephone numbers to a FAX transmitting process 55.

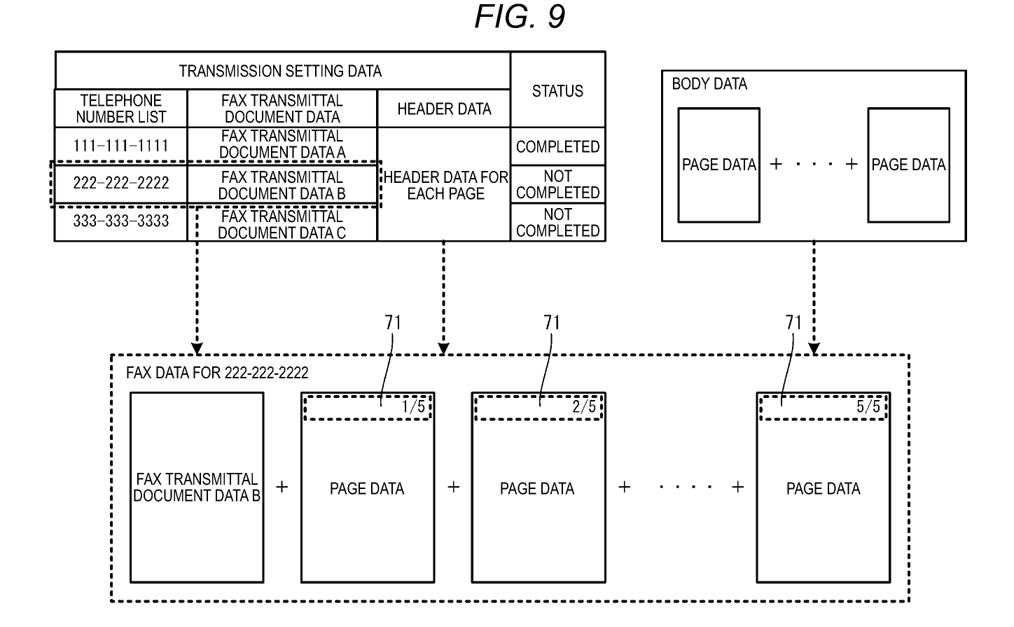

FIG. 9 is a schematic diagram for conceptually explaining a merging by the merging process 54. First, the merging process 54 associates the respective header data included in the transmission setting data with the corresponding page data. As shown in FIG. 9, in a header 71 represented by header data, a page number and a total number of pages of the page data corresponding to the header 71 are written. In the shown example, “5” is written as the total number of pages.

Subsequently, the merging process 54 selects one telephone number from the telephone number list included in the transmission setting data and links the FAX transmittal document data corresponding to the telephone number to the header of body data. In this way, FAX data corresponding to the selected telephone number is generated.

Subsequently, if the FAX transmitting process 55 is under transmission of FAX data, the merging process 54 performs standby until the transmission ends. On the other hand, if the FAX transmitting process 55 is not under transmission of FAX data, the merging process 54 outputs the selected telephone number and the FAX data for the telephone number to the FAX transmitting process 55.

The merging process 54 repeats the above-described process until all of the telephone numbers in the telephone number list are selected.

(2-5) FAX Transmitting Process

Returning to FIG. 4, the FAX transmitting process 55 is a process of controlling the FAX unit 35 to transmit FAX data to the corresponding telephone number each time the telephone number and the FAX data for the telephone number are output from the merging process 54.

(2-6) Cancellation Process

The cancellation process 56 is a process of deleting page data which has the same identification ID as an identification ID output together with a cancel command from the storage unit 37 when the cancel command is output from the setting receiving process 52.

(3) Process of PC-FAX System

Programs executed in the PC-FAX system 1 includes a PC-side control program 30 executed in the PC 2 and a FAX device-side control program 40 executed in the FAX device 3.

As shown in FIG. 2, the PC-side control program 30 is configured by a FAX driver program 30a as a generating and transmitting program and a transmission setting program 30b as a setting receiving program. The FAX driver program 30a is a program for setting generation conditions in the PC 2 and executing the generating and transmitting process 51. The transmission setting program 30b is a program for executing the setting receiving process 52 and the transmission setting data transmitting process 53 in the PC 2.

The FAX device-side control program 40 is a program for executing the merging process 54, the FAX transmitting process 55, and the cancellation process 56 in the FAX device 3.

Hereinafter, the processes by the respective programs will be described.

(3-1) FAX Driver Program

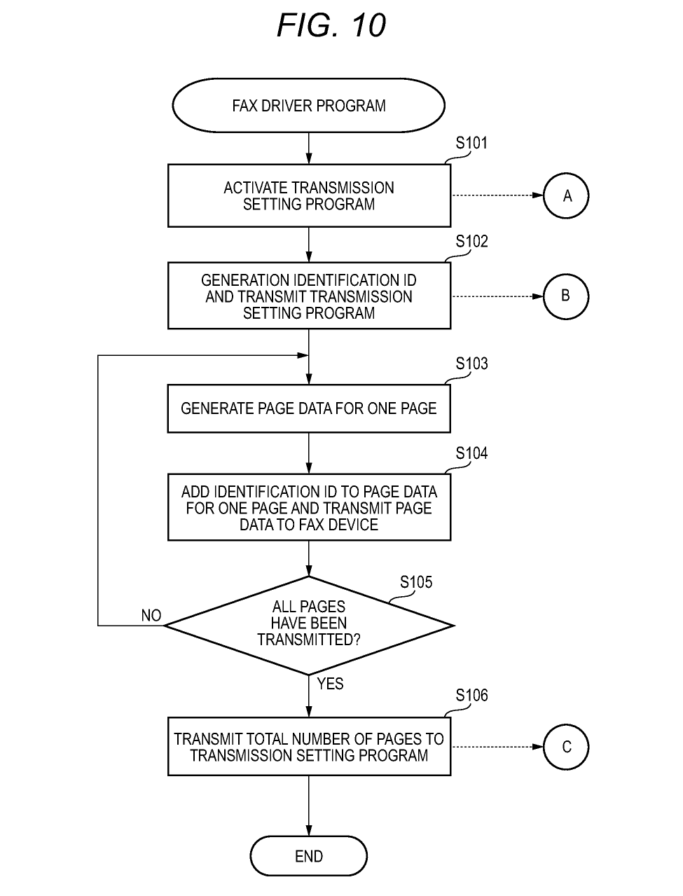

FIG. 10 is a flowchart showing the flow of processes executed by the CPU 21 (hereinafter simply referred to as a “FAX driver 30a”) executing the FAX driver program 30a. This process is started when a transmission target image is output from the FAX application 29 to the FAX driver 30a.

In S101, the FAX driver 30a starts the transmission setting program 30b.

In S102, the FAX driver 30a generates an identification ID for identifying body data and transmits the generated identification ID to the transmission setting program 30b.

In S103, the FAX driver 30a acquires an image corresponding to one page from the transmission target image output from the FAX application 29 and generates page data corresponding to one page representing the acquired image.

In S104, the FAX driver 30a adds the identification ID generated in S102 to the generated page data corresponding to one page and transmits the page data to the FAX device 3.

In S105, the FAX driver 30a determines whether the page data have been transmitted for all the images included in the transmission target image output from the FAX application 29. When the transmission is determined to be finished, the flow proceeds to S106. On the other hand, when the transmission is determined to be not finished, the flow returns to S103 and the process is repeated.

In S106, the FAX driver 30a transmits a total number of pages of the page data configuring the body data to the transmission setting program 30b.

(3-2) Transmission Setting Program

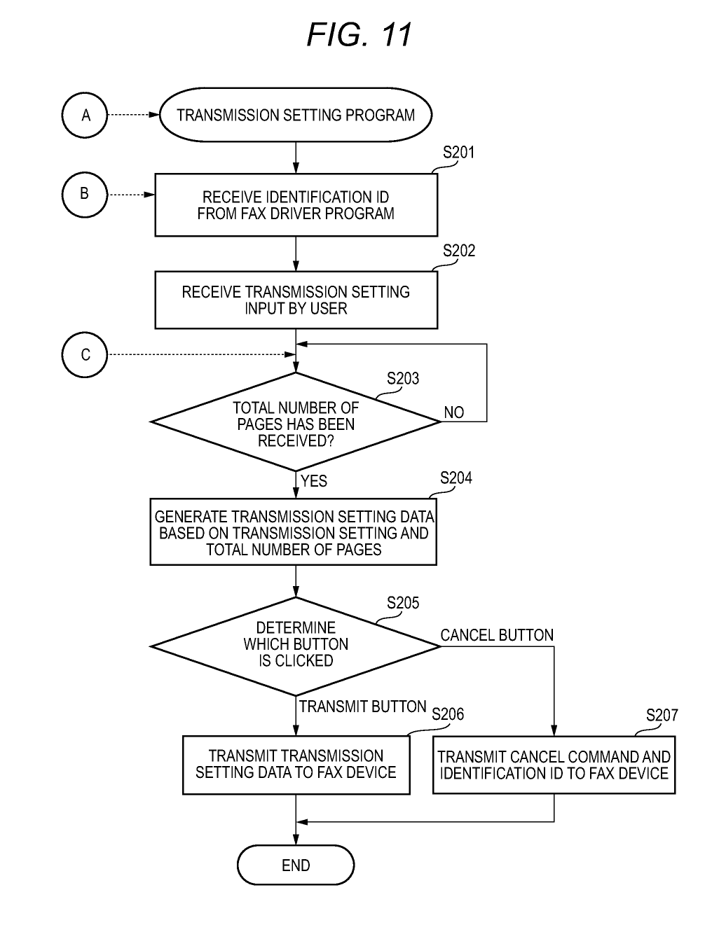

FIG. 11 is a flowchart showing the flow of processes executed by the CPU 21 (hereinafter simply referred to as a “transmission setting program 30b”) executing the transmission setting program 30b. This process is started when the transmission setting program 30b is started by the FAX driver program 30a.

In S201, the transmission setting program 30b receives an identification ID from the FAX driver 30a.

In S202, the transmission setting program 30b receives transmission setting input by the user 10.

In S203, the transmission setting program 30b determines whether the total number of pages is received from the FAX driver 30a. When it is determined that the total number of page is received, the flow proceeds to S204. On the other hand, when it is determined that the total number of pages is not received, standby is performed until the total number of pages is received.

In S204, the transmission setting program 30b generates transmission setting data based on the transmission setting and the total number of pages.

In S205, the transmission setting program 30b determines whether the transmit button 61f or the cancel button 61g is clicked. When it is determined that the transmit button 61f is clicked, the flow proceeds to S206. When it is determined that the cancel button 61g is clicked, the flow proceeds to S207.

In S206, the transmission setting program 30b adds the identification ID received in S201 to the transmission setting data and transmits the transmission setting data to the FAX device 3.

In S207, the transmission setting program 30b transmits a cancel command and the identification ID received in S201 to the FAX device 3.

(3-3) FAX Device-Side Control Program

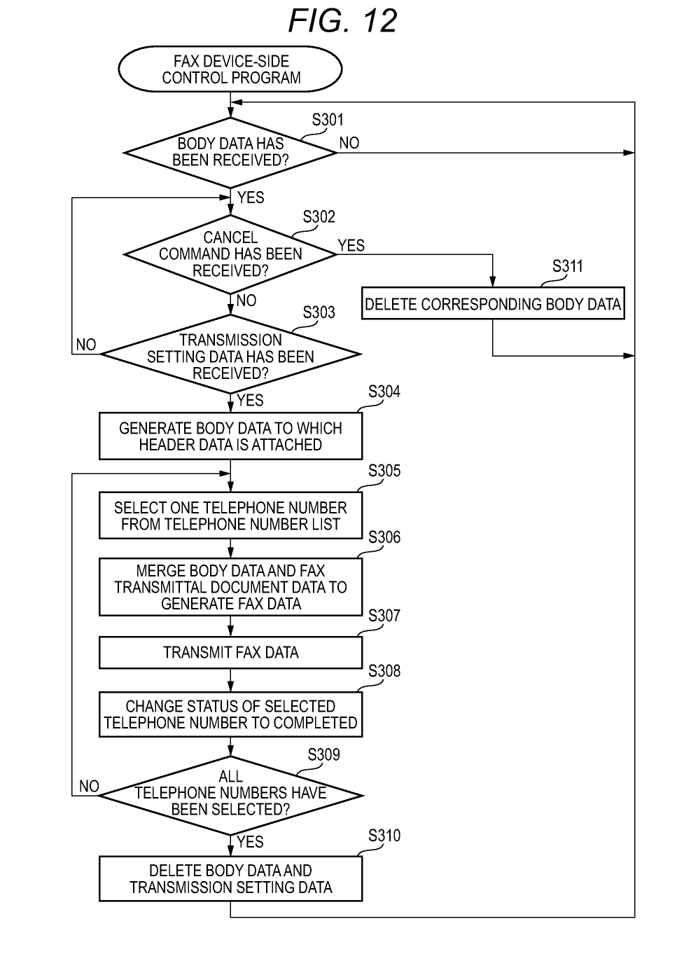

FIG. 12 is a flowchart showing the flow of processes executed by the CPU 31a (hereinafter simply referred to as a “control program 40) executing the FAX device-side control program 40. This process is always executed when power is input to the FAX device 3.

In S301, the control program 40 determines whether body data is received from the PC 2.

Specifically, when all of the page data have been transmitted to the FAX device 3, the FAX driver program 30a transmits data representing the completion of transmission of the body data to the FAX device 3. The FAX control program 40 determines whether the data representing the completion of transmission of the body data is received from the PC 2. When it is determined that the data is received, the flow proceeds to S302. On the other hand, when it is determined that the data is not received, this step is repeated until the data is received.

In S302, the control program 40 determines whether a cancel command is received from the PC 2. When it is determined that the cancel command is not received, the flow proceeds to S303. On the other hand, when it is determined that the cancel command is received, the flow proceeds to S311.

In S303, the control program 40 determines whether transmission setting data which has the same identification ID as the identification ID added to the body data is received. When it is determined that the transmission setting data is received, the flow proceeds to S304. On the other hand, when it is determined that the transmission setting data is not received, the flow returns to S302, and the process is repeated until the transmission setting data which has the same identification ID as the identification ID added to the body data is received.

In S304, the control program 40 generates FAX data to which header data is attached by merging the respective header data included in the received transmission setting data into the corresponding page data of the body data.

In S305, the control program 40 selects one telephone number from the telephone number list included in the received transmission setting data.

In S306, the control program 40 generates FAX data for the telephone number selected in S305 by merging the FAX transmittal document data corresponding to the telephone number selected in S305, which is the FAX transmittal document data included in the received transmission setting data, into the header of the body data to which the header data is attached.

In S307, the control program 40 controls the FAX unit 35 to start transmitting the FAX data generated in S306 to the FAX device 7 corresponding to the telephone number selected in S305. Here, the transmission is continued until all of the FAX data for the telephone number selected in S305 are completely transmitted.

In S308, the control program 40 changes the status of the telephone number selected in S305 to “completed” as shown in FIG. 9.

In S309, the control program 40 determines whether all of the telephone numbers present in the telephone number list have been selected. When it is determined that all of the telephone numbers have been selected, the flow proceeds to S310. On the other hand, when it is determined that all of the telephone numbers have not yet been selected, the flow proceeds to S305, and the process is repeated.

In S310, the control program 40 deletes the body data and the transmission setting data from the storage unit 37, and the flow returns to S310.

In S311, the control program 40 deletes all of the page data to which the identification ID received together with the cancel command is attached from the storage unit 37.

(4) Effects of Exemplary Embodiment

According to the PC-side control program 30 according to the above-described first exemplary embodiment, since the process of the setting receiving process 52 is started during the execution of the generating and transmitting process 51, at least a part of the processes of the generating and transmitting process 51 and at least a part of the processes of the setting receiving process 52 can be executed in parallel with each other.

Specifically, the generating and transmitting process 51 can generate page data and start transmitting the page data when the setting receiving process 52 is receiving a telephone number and setting information for generating a transmittal document from the user. The process of generating and transmitting the transmission setting data are generated from the transmission setting received from the setting receiving process 52 can be completed earlier than the process of generating a plurality of page data. As a result, immediately after the setting receiving process 52 is completed, the transmission setting data and the body data can be merged, and transmission of FAX can be performed.

As described above, according to the PC-side control program 30 according to the first exemplary embodiment, as compared to a case where the generating and transmitting process 51 is started after the setting receiving process 52 is finished, or a case where the setting receiving process 52 is started after the generating and transmitting process 51 is finished, it is possible to accelerate the time at which the FAX device 3 starts transmitting FAX data to the external FAX device 7.

Further, according to the PC-side control program 30, the transmission setting is the address of the FAX data, and the transmission setting data is the address data representing the address. Thus, at least a part of the generating and transmitting program 51 can be executed in parallel with the process of receiving the setting of the address of the FAX data.

Still further, according to the PC-side control program 30, in the setting receiving process 52, a plurality of addresses set for FAX data is received. Setting a plurality of addresses takes longer time than setting only one address. According to the PC-side control program 30, since at least a part of the processes of the generating and transmitting process 51 is executed in parallel with the process of receiving the setting of a plurality of addresses, the effect of accelerating the time at which the FAX device 3 starts transmitting FAX data is increased.

Still further, according to the PC-side control program 30, the transmission setting is the information used for generation of the FAX transmittal document attached to the FAX data, and the transmission setting data is the FAX transmittal document data generated based on the information. Therefore, at least a part of the processes of the generating and transmitting process 51 can be executed in parallel with the process of receiving the setting of the information used for generation of the FAX transmittal document data attached to the FAX data.

Still further, according to the PC-side control program 30, it is possible to generate the FAX transmittal document data representing the FAX transmittal document in which the total number of pages of the FAX data is written.

Still further, according to the PC-side control program 30, the generating and transmitting process 51 transmits the FAX data and the identification ID for uniquely identifying the FAX data to the FAX device 3, and the transmission setting data transmitting process 53 transmits the transmission setting data and the identification ID to the FAX device 3. Therefore, even when a plurality of PCs 2 transmits FAX data and transmission setting data to the FAX device 3, the FAX device 3 correlates the FAX data and the transmission setting data using the identification ID, so that FAX data transmitted from a certain PC 2 is prevented from being transmitted using the transmission setting data transmitted from a different PC 2.

Still further, according to the PC-side control program 30, when a cancel instruction is received by the setting receiving process 52, a cancel command to cancel the FAX transmission is transmitted to the FAX device 3. Thus, it is possible to prevent unnecessary page data from being left stored in the FAX device 3.

Moreover, according to the PC 2 according to the first exemplary embodiment, it is possible to accelerate the time at which the FAX device 3 starts transmitting FAX data to the external FAX device 7.

### Modification to Exemplary Embodiments

The present invention is not limited to the above-described exemplary embodiments. For example, the following embodiments are also included in the technical scope of the present invention.

(1) In the above-described exemplary embodiment, a case in which the generating and transmitting process 51 is started first, and the setting receiving process 52 is started before the generating and transmitting process 51 is finished has been described as an example. Alternatively, the setting receiving process 52 and the generating and transmitting process 51 may be started substantially at the same time. Further, the setting receiving process 52 may be started first, and the generating and transmitting process 51 may be started before the setting receiving process 52 is finished.

Further, the process executed in the setting receiving process 52 in parallel with the generating and transmitting process 51 may be, for example, “the process of receiving the setting of a telephone number” and may be “the process of receiving the setting of transmittal document information.”

For example, after “the process of receiving the setting of a telephone number” in the setting receiving process 52, the execution of the generating and transmitting process 51 may be started, and the generating and transmitting process 51 and “the process of receiving the setting of transmittal document information” may be executed in parallel. Alternatively, after “the process of receiving the setting of transmittal document information” in the setting receiving process 52 is finished, the execution of the generating and transmitting process 51 may be started, and the generating and transmitting process 51 and “the process of receiving the setting of a telephone number” may be executed in parallel.

(2) In the above-described exemplary embodiment, the FAX transmittal document data has been transmitted from the transmission setting data transmitting process 53 to the FAX device 3. Alternatively, instead of transmitting the FAX transmittal document data, transmittal document information for generating the FAX transmittal document may be generated, and the FAX device 3 may generate the FAX transmittal document data based on the transmittal document information.

(3) In the above-described exemplary embodiment, a personal computer has been described as an example of the information processing apparatus. Alternatively, the information processing apparatus may be a mobile phone and may be a mobile information terminal.

(4) In the above-described exemplary embodiment, the FAX device 3 having only the FAX function has been described as an example of the FAX device. Alternatively, the FAX device may be a multi-function apparatus having a print function, a copy function, a scanner function, and the like.

(5) In the above-described exemplary embodiment, although the PC 2 and the FAX device 3 is connected through the communication network 4, the present invention is not limited to this. For example, the present invention can be applied to a system in which the PC 2 and the FAX device 3 are connected in a one-to-one relation using a universal serial bus (USB) connection or a parallel connection, for example. In this case, it is not always necessary to transmit the identification ID.

(6) In the above-described exemplary embodiment, since it is configured such that the number of pages to be transmitted is displayed in the transmittal document preview screen 64, the total number of pages is transmitted from the generating and transmitting process 51 to the setting receiving process 52. However, the present invention is not limited to this. The number of pages to be transmitted may not be displayed in the transmittal document preview screen 64. That is, the total number of pages may be output from the generating and transmitting process 51 to the transmission setting data transmitting process 53.

What is claimed is:

1. A non-transitory computer-readable medium having a facsimile control program stored thereon and readable by a computer installed in an information processing apparatus, the facsimile control program, when executed by the computer, causes the computer to perform operations comprising:
a generating and transmitting process of generating facsimile data based on a transmission target image and transmitting the generated facsimile data to a facsimile device;
a setting receiving process of receiving a transmission setting of the facsimile data from a user; and
a transmission setting data transmitting process of transmitting transmission setting data based on the transmission setting received by the setting receiving process to the facsimile device,
wherein the facsimile control program is configured to cause the computer to start the generating and transmitting process and the setting receiving process at the same time or start one of the generating and transmitting process and the setting receiving process during execution of another one of the generating and transmitting process and the setting receiving process.

2. The non-transitory computer-readable medium according to claim 1,
wherein the facsimile control program is configured to cause the computer to start the setting receiving process during execution of the generating and transmitting process.

3. The non-transitory computer-readable medium according to claim 1,
wherein the setting receiving process is started by being activated by the generating and transmitting process before the transmission of the facsimile data by the generating and transmitting process is completed.

4. The non-transitory computer-readable medium according to claim 3,
wherein the generating and transmitting process activates the setting receiving process before staring the generation of the facsimile data.

5. The non-transitory computer-readable medium according to claim 3,
wherein the facsimile control program is made up of a plurality of programs including a generating and transmitting program for executing the generating and transmitting process and a setting receiving program for executing the setting receiving process, and
wherein the generating and transmitting program starts the setting receiving process by activating the setting receiving program.

6. The non-transitory computer-readable medium according to claim 1,
wherein the transmission setting is an address of the facsimile data, and
wherein the transmission setting data is address data representing the address.

7. The non-transitory computer-readable medium according to claim 6,
wherein in the setting receiving process, setting of a plurality of addresses is received in relation to the facsimile data.

8. The non-transitory computer-readable medium according to claim 1,
wherein the transmission setting is information used for generation of a transmittal document attached to the facsimile data, and
wherein the transmission setting data transmitting process comprises transmitting the information used for generating the transmittal document or transmittal document data that is generated based on the information to the facsimile device.

9. The non-transitory computer-readable medium according to claim 8,
wherein a total number of pages of the facsimile data is described in the transmittal document.

10. The non-transitory computer-readable medium according to claim 1,
wherein in the generating and transmitting process, the facsimile data and identification information for uniquely identifying the facsimile data are transmitted to the facsimile device, and
wherein in the transmission setting data transmitting process, the transmission setting data and the identification information are transmitted to the facsimile device.

11. The non-transitory computer-readable medium according to claim 1, the operations further comprising:
a cancel receiving process of receiving a cancel instruction to cancel facsimile transmission after the generation of the facsimile data by the generating and transmitting process is started; and
a cancellation process of transmitting a cancel command to cancel facsimile transmission to the facsimile device upon receiving the cancel instruction by the cancel receiving process.

12. An information processing apparatus comprising:
a setting receiving unit configured to receive a transmission setting of facsimile data from a user;
a generating and transmitting unit configured to generate facsimile data based on a transmission target image and transmit the generated facsimile data to a facsimile device; and
a transmission setting data transmitting unit configured to transmit transmission setting data based on the transmission setting received by the setting receiving unit to the facsimile device,
wherein the information processing apparatus is configured to start operations of the generating and transmitting unit and the setting receiving unit at the same time or start operation of one of the generating and transmitting unit and the setting receiving unit during operation of another one of the generating and transmitting unit and the setting receiving unit.

13. A facsimile system comprising a facsimile device and an information processing apparatus,
wherein the information processing apparatus comprises:
a setting receiving unit configured to receive a transmission setting of facsimile data from a user;
a generating and transmitting unit configured to generate facsimile data based on a transmission target image and transmit the generated facsimile data to the facsimile device; and
a transmission setting data transmitting unit configured to transmit transmission setting data based on the transmission setting received by the setting receiving unit to the facsimile device,
wherein the information processing apparatus is configured to start operations of the generating and transmitting unit and the setting receiving unit at the same time or start operation of one of the generating and transmitting unit and the setting receiving unit during operation of another one of the generating and transmitting unit and the setting receiving unit, and
wherein the facsimile device comprises:
a receiving unit configured to receive the facsimile data and the transmission setting data from the information processing apparatus; and
a transmitting unit configured to transmit the facsimile data received by the receiving unit using the transmission setting data received by the receiving unit.

14. The facsimile system according to claim 13,
wherein the information processing apparatus further comprises:
a cancel receiving unit configured to receive a cancel instruction to cancel facsimile transmission after the generation of the facsimile data by the generating and transmitting unit is started; and
a canceling unit configured to transmit a cancel command to cancel facsimile transmission to the facsimile device when the cancel receiving unit receives the cancel instruction, and
wherein the facsimile device further comprises a deleting unit configured to delete the facsimile data having been received by the receiving unit from a memory upon receiving the cancel command.

15. The facsimile system according to claim 13,
wherein the receiving unit is configured to receive the facsimile data, identification information for uniquely identifying the facsimile data, and the identification information and the transmission setting data from the information processing apparatus, and
wherein the transmitting unit is configured to specify the corresponding facsimile data and the corresponding transmission setting data based on the identification information and transmit the facsimile data using the transmission setting data.

16. A facsimile control method for an information processing apparatus, the facsimile control method comprising:
a generating and transmitting step of generating facsimile data based on a transmission target image and transmitting the generated facsimile data to a facsimile device;
a setting receiving step of receiving a transmission setting of the facsimile data from a user; and
a transmission setting data transmitting step of transmitting transmission setting data based on the transmission setting received by the setting receiving step to the facsimile device,
wherein the facsimile control program is configured to cause the computer to start the generating and transmitting step and the setting receiving step at the same time or start one of the generating and transmitting step and the setting receiving step during execution of another one of the generating and transmitting step and the setting receiving step.
